(19) United States
(12) Patent Application Publication
(10) Pub. No.: US 2013/0274000 A1
(43) Pub. Date: Oct. 17, 2013

(54) MODIFYING USE OF RESOURCES WITHIN A CLOUD-BASED GAMING PLATFORM

(71) Applicant: METEOR ENTERTAINMENT, INC., Seattle, WA (US)

(72) Inventors: Sarah Novotny, Seattle, WA (US); Nicholas Herring, Seattle, WA (US); Cyrus Durgin, Seattle, WA (US)

(73) Assignee: METEOR ENTERTAINMENT, INC., Seattle, WA (US)

(21) Appl. No.: 13/797,835

(22) Filed: Mar. 12, 2013

Related U.S. Application Data
(60) Provisional application No. 61/622,740, filed on Apr. 11, 2012.
(60) Provisional application No. 61/718,686, filed on Oct. 25, 2012.

(51) Int. Cl. A63F 13/12

(52) U.S. Cl. CPC A63F 13/12
USPC 463/25

(57) ABSTRACT

A computing platform, system, and method for modifying computing resources that provide and/or support an online game is described. In some implementations, the computing platform determines that one or more cost metrics associated with a currently running online game do not fall with acceptable ranges, and modify and/or adjust the use of computing resources providing the online game.

### CROSS REFERENCE TO RELATED APPLICATIONS

This application is related to, and claims the benefit of, U.S. Provisional Patent Application No. 61/622,740, titled CLOUD-BASED GAMING PLATFORM (filed Apr. 11, 2012), and U.S. Provisional Patent Application No. 61/718,686, titled MODIFYING USE OF RESOURCES WITHIN A CLOUD-BASED GAMING PLATFORM (filed Oct. 25, 2012), each of which is herein incorporated by reference in its entirety. This application is related to U.S. patent application Ser. No. ______, titled A COMPUTING PLATFORM FOR SUPPORTING MASSIVELY MULTI-PLAYER ONLINE GAMES (filed Mar. 12, 2013, Attorney Docket No. 876908003US), and U.S. patent application Ser. No. ______, titled A COMPUTING PLATFORM FOR SUPPORTING MASSIVELY MULTI-PLAYER ONLINE GAMES (filed Mar. 12, 2013, Attorney Docket No. 876908004US), each of which is herein incorporated by reference in its entirety. To the extent that the foregoing applications and/or any other materials herein incorporated by reference conflict with the present disclosure, the present disclosure controls.

### BACKGROUND

A massively multi-player online game (MMO or MMOG) is a multiplayer video game capable of supporting hundreds, thousands, or millions of simultaneous players. A MMO may be, for example, a role playing game, a first person shooter game, a real-time or turn-based strategy game, a simulation game, a sports game, a casual game, and so on. Game publishers provide a gaming environment via the Internet or other public or private networks, enabling players at personal computers, mobile devices, game consoles, and other client devices to have access to the game.

The emergence of free-to-play (F2P) online games has changed the monetization paradigm for video games from sales of a product (the game itself) to one of micro-transactions within a game. These in-game purchases may directly impact game balance and game server security, among other things. In fact, many garners worry that F2P games are in fact P2W (pay-to-win) games, and are often reluctant to play newly introduced games. For example, gamers who believe that a game is P2W are unlikely to continue playing the game, and even less likely to make in-game purchases themselves. Losing garners that would normally spend money within a game introduces many problems in to the F2P model of gaming. Without a consistent player:revenue ratio in the F2P model, losses are borne by dedicated, long-term, and/or high-spending players, by the game publisher, or by all parties involved. Additionally, a F2P game should facilitate garners who do not spend money to play the game, without adversely impacting the other players within the game.

Typically, a MMO is supported by game servers that communicate directly with client devices to provide game play and various third party services to players during the game play. FIG. 1 depicts a conventional computing environment 100 for a MMO. The conventional computing environment 100 includes one or more game servers 110 that host and support game play for the MMO, and communicate with client devices 120 associated with players of the MMO. Typically, the game servers 110 are hardware based servers controlled and/or operated by the provider of the MMO, such as a game publisher. In addition to game play, the conventional computing environment 100 may also provide 3^{rd} party services 115, such as player communication components (e.g., VOIP), game servers 110, store components (e.g., in game stores), and so on, directly via the game servers 110.

Utilizing game provider controlled hardware devices to provide the game play, as well as directly providing 3^{rd} party services via such hardware devices, may lead to various problems and drawbacks associated with providing engaging, entertaining gaming experiences to players of a massively multi-player online game. For example, the game provider may find scalability of the game to be difficult and/or cost inefficient, may encounter issues with providing updated and seamless 3^{rd} party services within a game, among other drawbacks.

Therefore, the need exists for a computing environment and system that overcomes the above problems associated with providing massively multiplayer online games, as well as one that provides additional benefits and features.

### BRIEF DESCRIPTION OF THE FIGURES

FIG. 1 is a block diagram illustrating components of a conventional gaming environment.

FIGS. 2A-2B are block diagrams illustrating a cloud-based computing platform that supports massively multi-player online games.

FIG. 3A is a block diagram illustrating components of a platform manager module.

FIG. 3B is a block diagram illustrating components of a decision engine module.

FIG. 4 is a flow diagram illustrating a routine for performing an action within a computing platform providing an online game based on an analysis of one or more financial metrics associated with the provided game.

FIG. 5 is a flow diagram illustrating a routine for performing an action within a computing platform providing an online game based on an analysis of a cost per user per time period associated with the provided game.

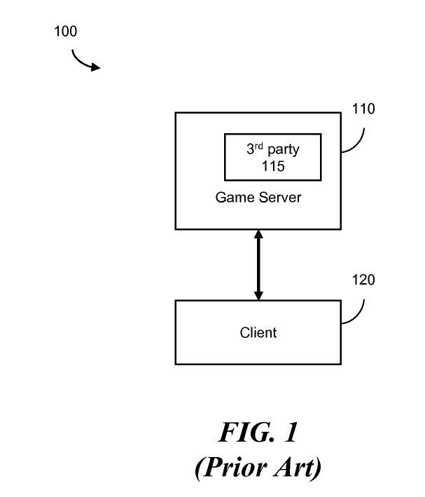

### DETAILED DESCRIPTION

Overview

A computing platform for providing and/or supporting an online video game, such as a massively multi-player online game (MMO, MMG, MMOG, MMORPG, and so on), is described. The computing platform, in some implementations, is a multi-tenant video game publishing platform designed to reduce complexity in the publishing and operation of online games, as well as deliver various levels of telematic-based modifications, among other things. The computing platform may utilize on-demand computing power from multiple public cloud services vendors (e.g., Amazon's AWS, the Rackspace cloud, Microsoft's Azure, and so on), as well as locally or privately provided cloud services, to provide a scalable, affordable and/or high performance gaming environment, among other benefits. Additionally or alternatively, in some implementations, the computing platform utilizes network performance and geo-location data to optimize game play for a supported MMO.

The computing platform may support various systems and methods utilizing some or all of the features described herein, such as systems and methods that perform actions based on financial, cost, or other monetary information associated with providing an online game. For example:

In some implementations, the technology provides a system for adjusting a use of computing resources supporting an online game. The system may include an information component, wherein the information component is configured to obtain information associated with a current financial status of the online game, and an action component, wherein the action component is configured to perform an action in response to determining that the current financial status of the online game does not satisfy certain criteria for the online game.

In some implementations, the technology provides a method for modifying use of cloud-based computing resources that support a massively multi-player online game. The method determines that one or more metrics associated with a cost to a game publisher to provide the massively multi-player online game using a current number of cloud-based computing resources do not satisfy certain criteria and adds or removes one or more cloud-based computing resources based on the determination.

In some implementations, the technology provides a method for modifying use of cloud-based server instances providing an online game to users at client devices. The method receives information associated with providing the online game, calculates a value for a financial metric associated with the online game using the received information, determines that the value of the financial metric satisfies a rule to add or remove at least one cloud-based server instance used to provide the online game to users at client devices, and performs an action to add or remove the at least one cloud-based server instanced based on the determination.

In some implementations, the technology provides a method for modifying use of cloud-based computing resources currently supporting a massively multi-player online game. The method calculates a cost per user per hour associated with using one or more cloud-based game instances to provide a currently running massively multi-player online game, determines that the calculated cost per user per hour does not satisfy one or more game play criteria associated with cost for providing the massively multi-player online game, and provisions or removes at least one additional cloud-based game instance based on the determination.

In some implementations, the technology provides a computing platform that supports an online game, which includes a platform manager configured to modify utilization of cloud-based server instances provisioned to provide the online game to client devices associated with players of the online game and a decision engine configured to transmit instructions to the platform manager when the decision engine determines that a value for a cost per user per hour to provide the online game does not fall within a range of acceptable values for a cost per user per hour to provide the online game.

The computing platform, and associated systems and methods will now be described with respect to various embodiments, examples, and/or implementations. The following description provides specific details for a thorough understanding of, and enabling description for, these embodiments of the platform. However, one skilled in the art will understand that the platform and associated systems and methods may be practiced without these details. In other instances, well-known structures and functions have not been shown or described in detail to avoid unnecessarily obscuring the description of the embodiments of the platform.

The terminology used in the description presented below is intended to be interpreted in its broadest reasonable manner, even though it is being used in conjunction with a detailed description of certain specific embodiments of the platform. Certain terms may even be emphasized below; however, any terminology intended to be interpreted in any restricted manner will be overtly and specifically defined as such in this Detailed Description section.

The MMO Computing Platform

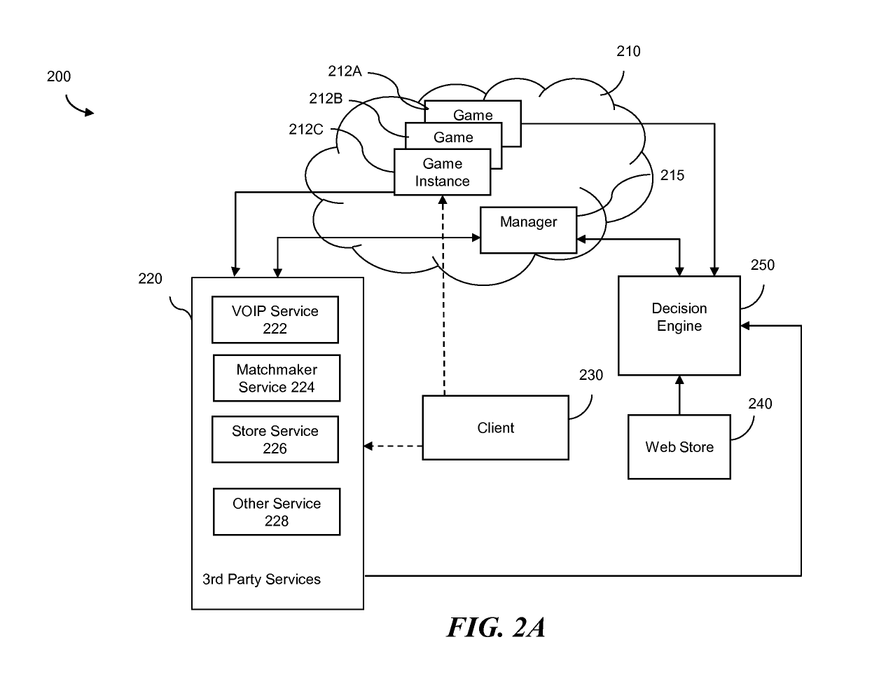

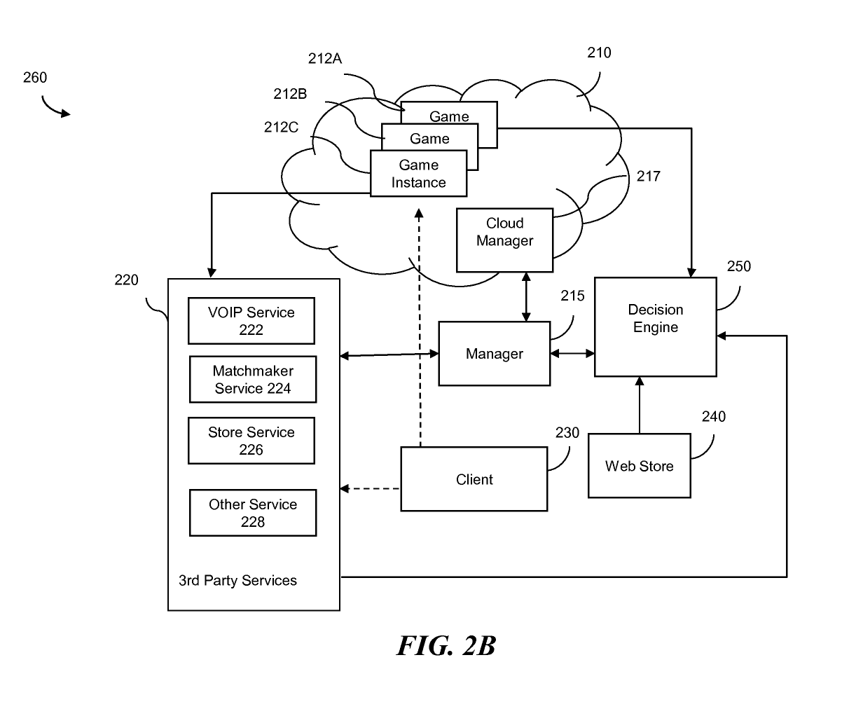

A computing platform that establishes and/or provides a cloud-based, scalable, computing environment in which to support a massively multi-player online game to many users or players located at client devices is described. FIG. 2A depicts various components of such a cloud-based computing platform 200.

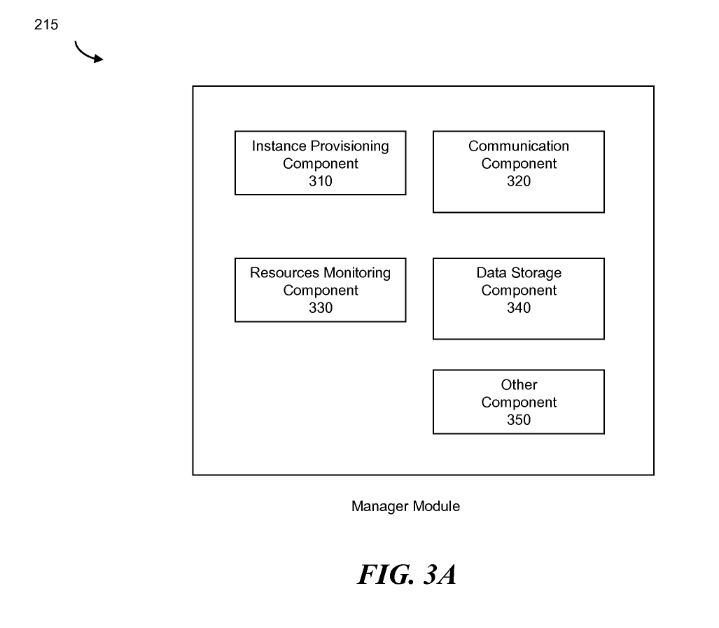

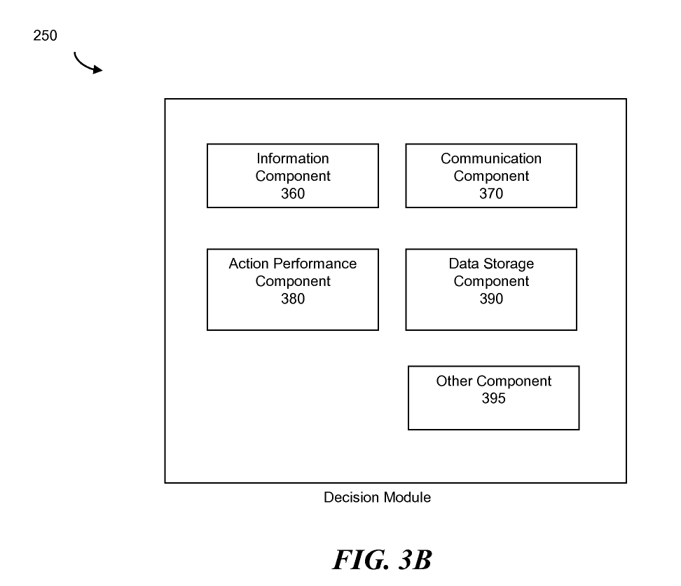

FIGS. 2A-3B and the following discussion provide a brief, general description of a suitable computing environment in which the MMO computing platform and various associated systems and methods can be implemented. Although not required, aspects of the platform are described in the general context of computer-executable instructions, such as routines executed by a general-purpose computer, e.g., a server computer, wireless device, game console, and/or personal computer. Those skilled in the relevant art will appreciate that the system can be practiced with other communications, data processing, or computer system configurations, including: Internet appliances, network PCs, mini-computers, mainframe computers, cloud-based computers, virtual machines, and the like. Indeed, the terms “computer,” “host,” and “host computer” are generally used interchangeably herein, and refer to any of the above devices and systems, as well as any data processor.

Aspects of the computing platform can be embodied in a special purpose computer or data processor that is specifically programmed, configured, or constructed to perform one or more of the computer-executable instructions explained in detail herein. Aspects of the computing platform can also be practiced in distributed computing environments where tasks or modules are performed by remote processing devices, which are linked through a communications network, such as a Local Area Network (LAN), Wide Area Network (WAN), Storage Area Network (SAN), Fibre Channel, or the Internet. In a distributed computing environment, program modules may be located in both local and remote memory storage devices.

Aspects of the computing platform may be stored or distributed on computer-readable media, such as computer-readable storage media, tangible computer-readable media, and/or tangible computer-readable storage media, including magnetically or optically readable computer discs, hard-wired or preprogrammed chips (e.g., EEPROM semiconductor chips), nanotechnology memory, biological memory, or other tangible data storage media. Non-transitory computer-readable media include tangible media such as hard drives, CD-ROMs, DVD-ROMS, and memories such as ROM, RAM, and Compact Flash memories that can store instructions and other storage media. Signals on a carrier wave such as an optical or electrical carrier wave are examples of transitory computer-readable media. Moreover, the computing platform may include computing resources typical of an “Infrastructure as a Service” (IaaS) model, such as resources providing cloud-based virtual machines, servers, storage, load balancing, network architectures, and so on, computing resources typical of a “Platform as a Service” (PaaS) model, such as resources providing run-time computing, databases, web servers, development tools, and so on, and/or computing resources typical of a “Software as a Service” (SaaS) model, such as resources providing CRM, communications, virtual desktops, games, and so on, among other resources. Indeed, computer implemented instructions, data structures, screen displays, and other data under aspects of the computing platform may be distributed over the Internet or over other networks (including wireless networks), on a propagated signal on a propagation medium (e.g., an electromagnetic wave(s), a sound wave, etc.) over a period of time, or they may be provided on any analog or digital network (packet switched, circuit switched, or other scheme). Those skilled in the relevant art will recognize that portions of the computing platform reside on a server computer, while corresponding portions reside on a client computer, and thus, while certain hardware platforms are described herein, aspects of the system are equally applicable to nodes on a network.

Referring back to FIG. 2A, the computing platform 200 utilizes a cloud-based services computing environment 210 that provisions, establishes, and/or supports one or more game instances 212A-C, each providing a massively multi-player online game and/or various aspects of the MMO. The cloud-based computing environment 210 includes computing resources that facilitate provisioning of the game instances 212A-C to a heterogeneous group of client devices 230 associated with players of the MMO.

For example, the cloud-based computing environment 210 may include computing resources typical of an IaaS model, such as resources providing cloud-based virtual machines, servers, storage, load balancing, network architectures, and so on, computing resources typical of a PaaS model, such as resources providing run-time computing, databases, web servers, development tools, and so on, and/or computing resources typical of an SaaS model, such as resources providing CRM, communications, virtual desktops, games, and so on, among other resources.

The cloud-based computing environment 210 may be formed of a variety of different cloud environments, including a public cloud, a community cloud, a hybrid cloud, a private cloud, an “intercloud,” or any other computing environment capable of and configured to provide infrastructure resources, platform resources, and/or software resources as a service to client devices located within a shared network, among other things.

The game instances 212A-C provide the MMO to client devices 230, such as laptops, smart phones, tablet computers, and so on, associated with players of the MMO, which directly connect and communicate with the instances 212A-C in order to play the game. The client devices 230 may access the game instances 212A-C in a variety of ways, such as via device supported web browsers, game specific software (such as apps downloaded to a device), game console software (such as software running on a PSP, PLAYSTATION, XBOX, NINTENDO, etc.) and so on. Thus, in some implementations, users of the client devices 230 directly connect with the game instances 212A-C within the cloud-based computing environment 210 in order to play a game, such as an MMO, that is provided by the game instances 212A-C.

The computing platform 200, in some implementations, also facilitates direct connections between the client devices 230 and services provided by 3^{rd} parties, or 3^{rd} party services 220, within a game. The platform 200 enables client devices to directly access a communication service 222, a store service 224, or other such services 226 associated with a game while playing the game. For example, the computing platform 200 facilitates a player at the client device 230 to access and communicate with other players via a VOIP service 222 while playing a game, without directly providing the VOIP service 222 to the player at the client device 230.

That is, the computing platform 200, in some implementations, provides various uniform APIs to developers of 3^{rd} party services 220 that enable the developers to access a game supported by the game instances 212A-C and provide various services to players at client devices 230. The computing platform 200 facilitates 3^{rd} party vendors to provide various services, such as communication services 222 (e.g., voice, text, chat, and so on), financial services 224 (e.g., storefronts, virtual catalogs, payment facilities, and so on) to players of a game without requiring any direct implementation of such services within the game itself. The computing platform 200 or 260 abstracts the access to game associated services to players at client devices 230 while providing the service providers a flexibility in access, implementation, and/or modification of the services they are providing to players of the game.

Thus, in some implementations, the computing platform 200 or 260 provides a uniform set of APIs to game developers for common components, including economy and item management, game and infrastructure analytics, voice and text communication, and/or matchmaking services. Thus, the game developer is freed from the burden of developing these services themselves, and/or integrating with heterogeneous third-party providers, among other benefits.

Many of the systems and methods described herein are provided by and/or performed by a platform manager module 215, which may be located in the cloud computing environment 210, or elsewhere within the computing platform (see FIG. 2B). The platform manager module 215, in some implementations, facilitates the scaling of the computing platform 200, including the addition and/or removal of game instances 212A-C based on a dynamic view of a gaming environment provided by the game instances 212A-C, among other things.

In some implementations, the platform manager module 215 receives information from a matchmaker service 235, such as a matchmaker service provided by the game publisher, and performs actions based on the received information. A matchmaker service 235 is, among other things, a component within the computing platform 200, often provided by a game publisher, that determines what users to bring together when creating or expanding a game being offered. For example, the matchmaker service 235 may receive a request from a user to join a specific MMO currently being played, identify a suitable point of entry for the user into the game based on information about the user (e.g., the user's location, skill level, historical game play, and so on), and match the user to other users within the currently playing MMO. The platform manager module 215, in some implementations, communicates with the matchmaker service 235 in order to obtain such information and perform various actions, such as actions associated with scaling a game, actions associated with modifying resources supporting the game, and so on. Further details regarding the interactions between the platform manager module 215, including interactions between the matchmaker service 235 and the platform manager module 215, are provided herein.

In some implementations, the platform manager module 215 receives information from a decision engine 250, such as a data driven decision module that is programmed and/or configured to track, obtain, analyze, and make decisions regarding some or all aspects of game supported by the game instances 212A-C, such as information from an associated web store 240, among other things. The platform manager module 215 may then perform actions based on the data provided by the decision engine 250, such as actions associated with adding or removing game instances 212A-C during game play, among other things. Further details regarding the decision engine 250, including interactions between the platform manager module 215 and decision engine 250, are provided herein.

As described herein, in some implementations, the platform manager module 215 may be located outside of the cloud-based computing environment 210, such as at a location associated with or physically proximate to a game publisher that utilized the computing platform described herein to provide an online game. FIG. 2B depicts a computing platform 260 that includes the platform manager module 215 located outside of the cloud-based computing environment 210. The platform manager module 215 may interact with computing resources within the cloud-based computing environment via a cloud manager module 217, which facilitates communications between the platform manager module 215 and various cloud-based and/or cloud supported resources, such as the game instances 212A-C.

The computing platforms 200 and/or 260 facilitate many different flows of data or other information between components, as shown by the arrows in the Figures. For example, in some implementations:
game play data (e.g., play instructions) may flow from client devices 230 to game instances 212A-C and/or to 3^{rd} party services;
information generated within the game instances 212A-C may flow to the decision engine 250, the 3^{rd} party services 220, the platform manager module 215, or elsewhere;
information generated by the 3^{rd} party services 220, the web store 240, the platform manager 215, the game instances 212A-C, or elsewhere, may flow to the decision engine 250;
information may flow from the platform manager module 215 to the decision engine 250, and from the decision engine 250 to the platform manager module 215;
information may flow between the platform manager module 215 and the 3^{rd} party services 220; and/or
information may flow between the matchmaker service 235 and the client devices 230, between the matchmaker service 235 and the platform manager module 215, and/or between the matchmaker service 235 and the game instances 212A-C; and so on.

Of course, one of ordinary skill in the art will realize that the computing platform 200 may facilitate the flow of information and/or data between other components and/or resources not specifically described herein.

The computing platform 200 or 260 may provide publically available services wrapped with a web services API. Such services may be accessed from a client or server, as well as any web properties surrounding a game. In some cases, the platform is resource-oriented, with each service responsible for managing its own persistence layer. For example, the services may expose an API accessible by any HTTPS client. Clients and servers mutually authenticate each other, when necessary, using industry standard SSL certificates. In some cases, clients and servers communicate using both the HTTP layer protocol (headers, and so on) and the entity body (request/response payload). Entity bodies may be JSON-encoded, and adhere to a common format across services. That is, services requests may be simple HTTP requests, where a HTTP verb dictates the type of operation being performed upon a specified resource. For example, any method-specific additional parameters may be included as query string parameters concatenated to a request URL.

As described herein, the platform manager module 215 may act as a layer of abstraction between the resources providing game play (e.g., game instances 212A-C) and client devices that enable users to play a game. The platform manager module 215, in some implementations, includes various components configured and/or programmed to facilitate the performance of various actions within the computing platform 200.

FIG. 3A depicts components of the platform manager module 215. In some implementations, the platform manager module 215 includes an instance provisioning component 310 configured and/or programmed to perform actions that cause the cloud-based computing environment 210 to add, remove, and/or otherwise modify the number, amount, and/or provisioning of cloud-based game servers, such as game instances 212A-C, utilized to provide a game to client devices 230. For example, the instance provisioning component 310 may provide instructions to the cloud-based computing environment 210 to launch and provision an additional game instance 212C when game play information identifies a need for additional supporting resources.

In some implementations, the platform manager module 215 includes a communication component 320 configured and/or programmed to facilitate communication between the platform manager module 215 and other components within the computing platform 200 or 260.

In some implementations, the platform manager module 215 includes a resources monitoring component 330 configured and/or programmed to track and/or monitor the operation of some or all of the resources within the computing platform 200 or 260. For example, the resources monitoring component 330 may monitor game play statistics associated with game instances 212A-C, may monitor users associated with a matchmaker service 235, and/or perform other telematics within the computing platform 200 or 260. The platform manager module 215 may also include a data storage component 340, such as various databases and/or memory, that store data associated with game play, computing platform resources and/or components, performed actions, data analyses, and so on.

The platform manager module 215 may also include other components 350, such as components that perform various different actions within the computing platform 200 or 260, components that determine and/or decide actions to be performed, components that generate reports, components that provide various load balancing or optimization of resources, and so on.

In some implementations, the platform manager module 215 receives information from the decision engine 250, and performs actions based on such information. FIG. 3B depicts components of the decision engine 250. In some implementations, the decision engine 250 includes an information component 360 configured and/or programmed to track, monitor, extract, and/or obtain data and other information from the computing platform 200 or 260. For example, the information component 360 may obtain information associated with a number of users playing a game, a number of game instances providing a game, telematics associated with the game or computing resources providing the game, a current cost to provide a game, and so on.

In some implementations, the decision engine includes a communication component 370 configured and/or programmed to facilitate communication between the decision engine 250 and other components within the computing platform 200 or 260.

In some implementations, the decision engine includes an action performance component 380 configured and/or programmed to perform various actions within the computing platform 200 or 260. For example, the action performance component 380 may cause the manager module 215 to add or remove a game instance based on information obtained by the information component 360.

The decision engine 250 may also include a data storage component 390, such as various databases and/or memory, that store data associated with game play, computing platform resources and/or components, performed actions, data analyses, and so on. The decision engine 250 may also include other components 395, such as components that determine and/or decide actions to be performed, components that generate reports, components that provide various load balancing or optimization of resources, and so on.

Thus, in some implementations, the computing platform 200 or 260 provides a cloud-based gaming environment which provides a layer of abstraction for users of the platform. The abstraction layer, facilitated by a platform manager module 215, enables the computing platform to scale its resources when needed, providing a cost efficient yet powerful computing environment in which to host an online game, such as a massively multi-player online game, among other benefits.

Further details regarding routines and/or techniques performed by resources within the computing platforms 200 and 260, such as routines and/or techniques performed by the platform manager module 215 or the decision engine 250, will now be described.

Modifying the Computing Platform Based on Financial Metrics

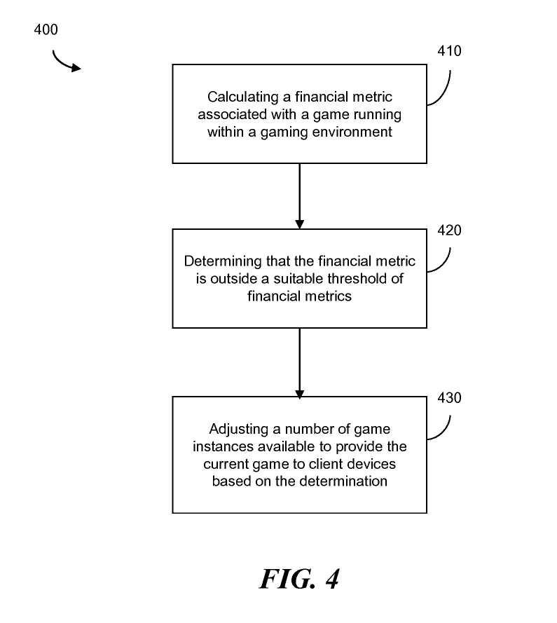

As described herein, in some implementations, the computing platform 200 or 260 facilitates the modification and/or adjustment of computing resources based on an analysis of financial metrics associated with a game being played. FIG. 4 is a flow diagram illustrating a routine 400 for performing an action within a computing platform providing an online game based on an analysis of one or more financial metrics associated with the provided game. The routine 400 may be performed by a variety of different systems within the computing platform 200 or 260, such as systems that include the platform manager module 215, systems that include the decision engine 250, and so on.

In step 410, the system calculates a financial metric associated with a game running and/or currently being played within a gaming environment supported by the computing platform. For example, the system, via the information component 360 of the decision engine 250, collects and/or obtains information associated with the game, and performs calculations or other determinations based on the collected information in order to calculate or determine a financial metric for the game being played. Example information that may be collected includes information associated with a number of users, information associated with data supporting game play, information associated with a number of resources being used, information associated with a cost for use of cloud-based resources (such as a cost for each game instance being utilized to provide the game), and so on.

In step 420, the system determines that the calculated financial metric falls outside a suitable threshold or range of financial metrics. For example, the system, via the information component 360 of the decision engine 250, determines that the calculated financial metric does not satisfy a rule or criteria associated with maintaining game play at current levels and/or with currently utilized resources (or, conversely, does satisfy a rule or criteria associated with adjusting game play to different levels and/or to different utilized resources). That is, the system may determine that the financial metric is less than optimal and does not satisfy rules governing costs associated with a supported game, and adjusts aspects of the computing platform providing the game accordingly.

In step 430, the system, in some cases automatically, adjusts, modifies, and/or augments the game instances currently running within the computing platform and providing the game to client devices. For example, the system, via the action performance component 380 of the decision engine 250 and/or the instance provisioning component 310 of the platform manager module 310, performs an action to modify and/or adjust operations supporting a game being played, such as an action that causes one or more game instances to be provisioned for use, one or more game instances to be removed from use, and so on.

For example, the system may receive information that indicates a game is utilizing more game instances than required, which leads to a calculation of a financial metric, such as a metric identifying an overall cost for the number of users playing a game. The system compares the calculated metric with a range of values for the metric that are related to an optimal or satisfactory deployment and/or utilization of computing resources, such as cloud-based computing resources. If the comparison determines that the calculated metric falls within a range of satisfactory values, the system maintains the current usage of resources, else the system modifies the current usage of resources. That is, when the calculated metric falls outside a satisfactory range, the system may add resources, remove resources, adjust the use of resources, adjust the use of certain resources, and so on.

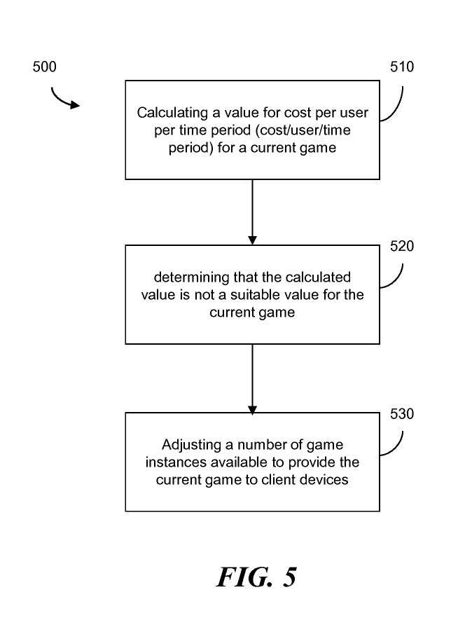

Thus, in some implementations, the system may perform actions based on the costs per gamer for a game supported by the computing platform. FIG. 5 is a flow diagram illustrating a routine 500 for performing an action within a computing platform providing an online game based on an analysis of a cost per user per time period associated with the provided game.

In step 510, the system calculates a value for a cost per user (cost/user) for a game within a given or current time period. For example, the system, via the information component 360, calculates a value of a cost per user per hour (cost/user/hr) for a game. The system may calculates values for many different time periods or increments, such as weeks, months, days, hours, minutes, time periods specific or relevant to the game, time periods associated with certain levels of activity or users, and so on. The system may obtain various types of information in order to calculate the value, such as information identifying a number of resources being used, information identifying a cost for the resources, information identifying a number of users, information identifying a number of certain types of users, information identifying a cost for certain resources, information identifying a predicted cost for use of resources, information identifying a trend or pattern of the costs of using resources (e.g., the slope of a plot of the cost per user of a game), and so on.

Various triggers may cause the system to perform routine 500 (or 400). In some cases, the system may perform routines 400 or 500 on an automatic, periodic basis, such as every hour, every 10 minutes, and so on. In some cases, the system may perform routines 400 or 500 in response to certain activity within a game, such as in response to a certain percentage increase/decrease in users, a certain percentage increase/decrease in data usage, a certain increase/decrease in use of 3^{rd} party services, and so on.

In step 520, the system determines the calculated value is not suitable for the game being played. For example, the system, via the information component 360, determines that a calculated value does not satisfy a rule or threshold attributed to satisfactory costs for providing the game.

In step 530, the system adjusts, in some cases automatically, a number of game instances currently being utilized to provide the game to client devices. For example, the system, via the action performance component 380 and/or the instance provisioning component 310, performs an action to modify and/or adjust a number of game instances 212A-C currently being utilized in providing a game to client devices.

For example, a game provider currently employs 12 game instances to provide a role playing game to 300 players. Each of the game instances cost $.50 per hour, or $6.00 per hour for 12 instances. The system calculates the current game play to cost $0.02 user/hour, which is within a suitable range of $0.015 to $0.025 user/hour for the game.

At a later time, 100 players stop playing, and the system calculates the new current game play to cost $0.03 user/hour. The system determines the new calculated value of the cost/user/hour of the game to be outside the suitable range for the game (and thus not satisfy the rules or criteria associated with the cost to provide the game), and automatically performs an action to employ fewer game instances, in order to achieve a satisfactory value for the cost/user/hour for the game. In this example, the system removes two game instances from being available for the game, reducing the cost per hour for the game instances to $5.00 per hour, which leads to a new value for the cost/user/hour for the game of $0.025, which satisfies the cost criteria for the game.

Thus, in some implementations, the computing platform 200 or 260 enables a game publisher to track costs associated with game play, and provision and/or utilize computing resources based on different techniques to limit or control such costs, among other benefits. That is, the computing platform 200 or 260 may utilize systems associated with various components, such as the platform manager module 215 and/or the decision engine 250, to dynamically perform routines 400 or 500 that optimally deploy computing resources with great efficiency and intelligence, among other benefits.

### CONCLUSION

Thus, in some implementations, the technology described herein provides a publishing platform that enables video game development houses to publish online games without relying on costly capital expenditures for technology infrastructure and complex third-party service integration, while still having enabling a game to scale to 100,000+ concurrent players.

From the foregoing, it will be appreciated that specific examples and implementations of the technology have been described herein for purposes of illustration, but that various modifications may be made without deviating from the spirit and scope of the technology. Accordingly, the system is not limited except as by the appended claims.

Unless the context clearly requires otherwise, throughout the description and the claims, the words “comprise,” “comprising,” and the like are to be construed in an inclusive sense, as opposed to an exclusive or exhaustive sense; that is to say, in the sense of “including, but not limited to.” The word “coupled”, as generally used herein, refers to two or more elements that may be either directly connected, or connected by way of one or more intermediate elements. Additionally, the words “herein,” “above,” “below,” and words of similar import, when used in this application, shall refer to this application as a whole and not to any particular portions of this application. Where the context permits, words in the above Detailed Description using the singular or plural number may also include the plural or singular number respectively. The word “or” in reference to a list of two or more items, that word covers all of the following interpretations of the word: any of the items in the list, all of the items in the list, and any combination of the items in the list.

The above detailed description of embodiments of the technology is not intended to be exhaustive or to limit the system to the precise form disclosed above. While specific embodiments of, and examples for, the technology are described above for illustrative purposes, various equivalent modifications are possible within the scope of the system, as those skilled in the relevant art will recognize. For example, while processes or blocks are presented in a given order, alternative embodiments may perform routines having steps, or employ systems having blocks, in a different order, and some processes or blocks may be deleted, moved, added, subdivided, combined, and/or modified. Each of these processes or blocks may be implemented in a variety of different ways. Also, while processes or blocks are at times shown as being performed in series, these processes or blocks may instead be performed in parallel, or may be performed at different times.

The teachings of the technology provided herein can be applied to other systems, not necessarily the technology described above. The elements and acts of the various embodiments described above can be combined to provide further embodiments.

These and other changes can be made to the s technology in light of the above Detailed Description. While the above description details certain embodiments of the system and describes the best mode contemplated, no matter how detailed the above appears in text, the system can be practiced in many ways. Details of the technology may vary considerably in implementation details, while still being encompassed by the technology disclosed herein. As noted above, particular terminology used when describing certain features or aspects of the technology should not be taken to imply that the terminology is being redefined herein to be restricted to any specific characteristics, features, or aspects of the technology with which that terminology is associated. In general, the terms used in the following claims should not be construed to limit the system to the specific embodiments disclosed in the specification, unless the above Detailed Description section explicitly defines such terms. Accordingly, the actual scope of the system encompasses not only the disclosed embodiments, but also all equivalent ways of practicing or implementing the system under the claims.

While certain aspects of the technology are presented below in certain claim forms, the inventors contemplate the various aspects of the technology in any number of claim forms. Accordingly, the inventors reserve the right to add additional claims after filing the application to pursue such additional claim forms for other aspects of the technology.

We claim:

1. A system for adjusting a use of computing resources supporting an online game, the system comprising:
an information component, wherein the information component is configured to obtain information associated with a current financial status of the online game; and
an action component, wherein the action component is configured to perform an action in response to determining that the current financial status of the online game does not satisfy certain criteria for the online game.

2. The system of claim 1, wherein the action component is configured to remove a computing resource from the computing resources supporting the online game.

3. The system of claim 1, wherein the action component is configured to add a computing resource to the computing resources supporting the online game.

4. The system of claim 1, wherein the action component is configured to remove a cloud-based game instance from the computing resources supporting the online game.

5. The system of claim 1, wherein the action component is configured to add a cloud-based computing instance to the computing resources supporting the online game.

6. The system of claim 1, wherein the information component is configured to obtain information associated with a current cost to provide the online game.

7. The system of claim 1, wherein the information component is configured to obtain information associated with a predicted cost to provide the online game in a certain time period.

8. A method performed by a computing platform for modifying use of cloud-based computing resources providing a massively multi-player online game, the method comprising:
determining that one or more metrics associated with a cost to a game publisher to provide the massively multi-player online game using a current number of cloud-based computing resources do not satisfy certain criteria; and
adding or removing one or more cloud-based computing resources based on the determination.

9. The method of claim 8, wherein adding or removing one or more cloud-based computing resources based on the determination includes adding a cloud-based server instance based on a determination that the one or more metrics do not satisfy at least one criterion associated with a minimum cost to provide the massively multi-player online game.

10. The method of claim 8, wherein adding or removing one or more cloud-based computing resources based on the determination includes removing a cloud-based server instance based on a determination that the one or more metrics do not satisfy at least one criterion associated with a maximum cost to provide the massively multi-player online game.

11. A computer-readable storage medium whose contents, if executed by a processor of a computing system, cause the computing system to perform a method for modifying use of cloud-based server instances providing an online game to users at client devices, the method comprising:
receiving information associated with providing the online game;
calculating a value for a financial metric associated with the online game using the received information;
determining that the value of the financial metric satisfies a rule to add or remove at least one cloud-based server instance used to provide the online game to users at client devices; and
performing an action to add or remove the at least one cloud-based server instanced based on the determination.

12. The computer-readable storage medium of claim 11, wherein calculating a value for a financial metric associated with the online game using the received information includes calculating a value for a current cost per player of the online game.

13. The computer-readable storage medium of claim 11, wherein calculating a value for a financial metric associated with the online game using the received information includes calculating a value for a cost per player within a current time period of the online game.

14. The computer-readable storage medium of claim 11, wherein calculating a value for a financial metric associated with the online game using the received information includes calculating a value for a cost per resource within a current time period of the online game.

15. A method performed by a processor of a computing system for modifying use of cloud-based computing resources currently supporting a massively multi-player online game, the method comprising:
calculating a cost per user per hour associated with using one or more cloud-based game instances to provide a currently running massively multi-player online game;
determining that the calculated cost per user per hour does not satisfy one or more game play criteria associated with cost for providing the massively multi-player online game; and
provisioning at least one cloud-based game instance to provide the currently running massively multi-player online game based on the determination.

16. The method of claim 15, further comprising:
recalculating a cost per user per hour associated with using the provisioned at least one cloud-based game instance to provide the currently running massively multi-player online game;
determining that the calculated cost per user per hour does not satisfy the one or more game play criteria associated with cost for providing the massively multi-player online game; and
provisioning at least one additional cloud-based game instance to provide the currently running massively multi-player online game based on the determination.

17. The method of claim 15, wherein provisioning at least one cloud-based game instance to provide the currently running massively multi-player online game based on the determination includes provisioning a game instance based on a cost to use the game instance.

18. The method of claim 15, wherein provisioning at least one cloud-based game instance to provide the currently running massively multi-player online game based on the determination includes provisioning a game instance based on a geographical location of the game instance with respect to geographical locations of users playing the massively multi-player online game.

19. A method performed by a processor of a computing system for modifying use of cloud-based computing resources currently supporting a massively multi-player online game, the method comprising:
calculating a cost per user per hour associated with using one or more cloud-based game instance to provide a currently running massively multi-player online game;
determining that the calculated cost per user per hour does not satisfy one or more game play criteria associated with cost for providing the massively multi-player online game; and
removing at least one cloud-based game instance currently providing the massively multi-player online game based on the determination.

20. The method of claim 19, wherein removing at least one cloud-based game instance currently providing the massively multi-player online game based on the determination includes removing a game instance based on a cost to use the game instance.

21. The method of claim 19, wherein removing at least one cloud-based game instance currently providing the massively multi-player online game based on the determination includes removing a game instance based on a geographical location of the game instance with respect to geographical locations of users playing the massively multi-player online game.

22. A computing platform that supports an online game, the computing platform comprising:
a platform manager, wherein the platform manager is configured to modify utilization of cloud-based server instances provisioned to provide the online game to client devices associated with players of the online game; and
a decision engine, wherein the decision engine is configured to transmit instructions to the platform manager when the decision engine determines that a value for a cost per user to provide the online game does not fall within a range of acceptable values for a cost per user to provide the online game.

23. The platform of claim 22, wherein the decision engine is configured to transmit instructions to the platform manager when the decision engine determines that a value for a cost per user in a specific time period of play does not fall within a range of acceptable values for the specific time period.

24. The platform of claim 22, wherein the decision engine is configured to transmit instructions to the platform manager when the decision engine determines that a value for a cost per user in a specific time period of play does not fall within a range of predicted values for the specific time period.

25. The platform of claim 22, wherein the decision engine is configured to transmit instructions to the platform manager when the decision engine determines that a value for a cost per user per hour does not fall within a range of acceptable values.

26. The platform of claim 22, wherein the decision engine is configured to transmit instructions to the platform manager when the decision engine determines that a value for a slope of a plot of a cost per user per does not fall within a range of acceptable values.
